(19) United States
(12) Patent Application Publication
(10) Pub. No.: US 2010/0131397 A1
(43) Pub. Date: May 27, 2010

(54) PROVIDING "ON BEHALF OF" SERVICES FOR MOBILE TELEPHONE ACCESS TO PAYMENT CARD ACCOUNT

(76) Inventors: Patrick Killian, Cottleville, MO (US); Sandeep Malhotra, Ballwin, MO (US)

Correspondence Address: BUCKLEY, MASCHOFF & TALWALKAR LLC, 50 LOCUST AVENUE, NEW CANAAN, CT, 06840, US

(21) Appl. No.: 12/323,016

(22) Filed: Nov. 25, 2008

(51) Int. Cl. G06Q 40/00

(52) U.S. Cl. 705/35

(57) ABSTRACT

A method includes receiving from an acquiring financial institution (FI) a request to translate a customer identifier into a primary account number (PAN). The method further includes determining whether the customer identifier is valid, and (if the customer identifier is determined to be valid) issuing a challenge to a mobile telephone operated by a customer identified by the customer identifier. The method also includes receiving a mobile personal identification number (PIN) from the customer, determining whether the mobile PIN is valid, and (if the received mobile PIN is determined to be valid) generating a security code. The method further includes transmitting, to the acquiring FI, the security code and the PAN that corresponds to the customer identifier.

### BACKGROUND

Embodiments disclosed herein relate to payment systems. In particular, some embodiments relate to methods, apparatus, systems, means and computer program products for implementing a payment system on the basis of a payment card system.

Payment card systems are in widespread use. A prominent payment card system is operated by the assignee hereof, MasterCard International Incorporated, and by its member financial institutions. There have been proposals to permit access to payment card systems via an account holder's mobile telephone. However, one barrier to commercialization of mobile-based access to payment card systems is the possible need for modifications of the computer systems by which card issuers and acquiring financial institutions participate in payment card systems. There are also issues related to transaction security.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a transaction-handling system in accordance with aspects of the present invention.

FIG. 2 is a block diagram of a computer that is part of the system of FIG. 1 and performs “on behalf of” (OBO) services.

FIG. 3 is a block diagram of a computer that is operated by an acquiring financial institution (FI) in the system of FIG. 1.

FIG. 4 is a flow chart that illustrates a process that may be performed by the acquiring FI computer of FIG. 3 in accordance with aspects of the present invention.

FIG. 5 is a flow chart that illustrates a process that may be performed by the OBO service provider computer of FIG. 2 in accordance with aspects of the present invention.

FIGS. 6A-6B together form a flow chart that illustrates a process that may be performed by the OBO service provider computer of FIG. 2 in accordance with other aspects of the present invention.

FIG. 7 is a block diagram that illustrates various functions that may be supported in some embodiments by the OBO service provider computer of FIG. 2.

### DETAILED DESCRIPTION

In general, and for the purpose of introducing concepts of embodiments of the present invention, a payment card system purchase transaction is initiated using the telephone number for a mobile telephone operated by the holder of a payment card account. A service provider performs “on behalf of” (OBO) services for either or both of the acquiring financial institution (FI) and the issuing FI. As is familiar to those who are skilled in the art, OBO services refer to services performed by a third party provider for an issuer FI or an acquirer FI in a payment card system. As is also well known, the acquirer FI is the organization that transmits a purchase transaction to a payment card system for routing to the issuer of the payment card account in question. Typically, the acquirer FI has an agreement with merchants, wherein the acquirer FI receives authorization requests for purchase transactions from the merchants, and routes the authorization requests to the issuers of the payment cards to be used for the purchase transactions. In some cases, the acquirer FI may contract out transaction handling services to a third party service provider. As used in this disclosure and the appended claims, “acquirer FI” includes both such FIs and third party service providers under contract to such FIs. The terms “acquirer”, “acquirer FI” and “acquiring FI” will be used interchangeably herein. The terms “issuer”, “issuer FI” and “issuing FI” will also be used interchangeably herein to refer to the FI that issued a payment card account to an account/card holder.

Continuing with the general overview of concepts of the invention, the OBO service provider may aid the acquirer and issuer by translating the card holder's mobile telephone number into the PAN (primary account number) for the payment card account in question. Further, the OBO service provider may handle a challenge-and-response security procedure via the card holder's mobile telephone. In some embodiments, the OBO service provider may be an intermediary between the merchant and the acquirer. In other embodiments (or in other types of transactions in the same embodiment) the acquirer may bring the OBO service provider in to assist on a transaction request received by the acquirer.

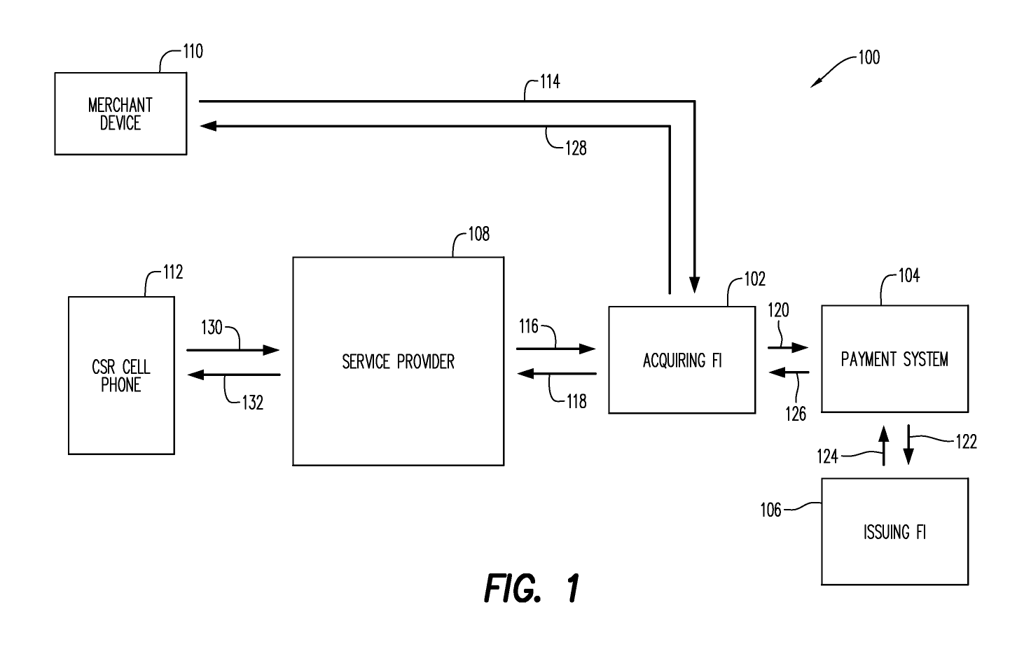

FIG. 1 is a block diagram that illustrates a transaction-handling system 100 in accordance with aspects of the present invention. The transaction-handling system 100 includes an acquirer 102, payment system 104 and an issuer 106. Block 102 may be considered to represent both the acquiring FI and a computer (not separately indicated) that handles the acquirer functions for purchase transactions in a conventional payment card system. Except for certain modifications described herein, the acquirer 102 may function in a generally conventional manner.

The payment system 104 may operate in a conventional manner. An example of a suitable payment system is the “Banknet” system operated by MasterCard International Inc., the assignee hereof. As is well-known by those who are skilled in the art, the payment system 104 routes purchase transaction authorization requests from acquirers to issuers, and routes purchase transaction authorization responses back from the issuers to the acquirers. A separate system for clearing purchase transactions may also be provided by the operator of the payment system 104 but is not indicated herein in the interests of simplifying the drawing.

Block 106 may be considered to represent both the issuer FI and its computer by which it participates in the payment card system. The issuer FI 106 may operate in a conventional manner to receive authorization requests via the payment system 104 and to transmit authorization responses back to acquirers via the payment system 104.

FIG. 1 shows only components of the transaction-handling system 100 that are involved in handling one transaction. In practice, the transaction-handling system 100 may include many more acquiring FIs than the single acquirer 102 shown in FIG. 1, and may include many more issuers than the single issuer 106 shown in FIG. 1.

The transaction-handling system 100 also includes an OBO service provider computer 108 which exchanges messages with the acquirer 102 and provides services which are described below. Also shown in FIG. 1 is a merchant device 110 which initiates a purchase transaction to be processed by the transaction-handling system 100. The merchant device 110 may be, for example, a point of sale terminal or a commerce-enabled mobile telephone.

(Although only one merchant device 110 is shown in FIG. 1, in practice there may be a large number of merchant devices that may from time to time transmit purchase transaction authorization requests to the acquirer computer 102.)

Also depicted in FIG. 1 is a mobile telephone 112 which is operated by the individual who is making the purchase represented by the purchase transaction.

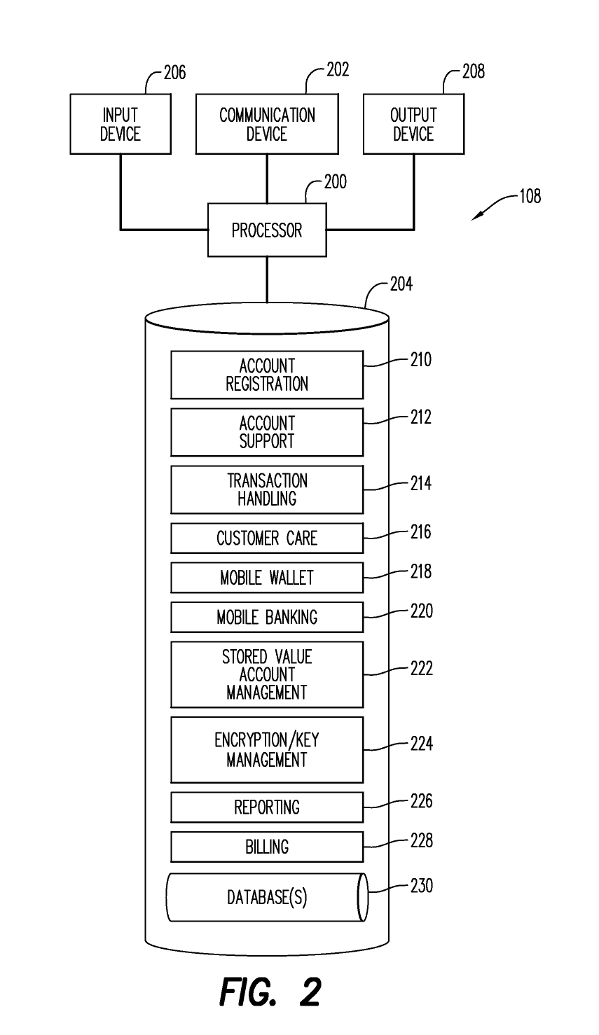

FIG. 2 is a block diagram of the OBO service provider computer 108.

The OBO service provider computer 108 may be conventional in its hardware aspects but may be controlled by software to cause it to operate in accordance with aspects of the present invention.

The OBO service provider computer 108 may include a computer processor 200 operatively coupled to a communication device 201, a storage device 204, an input device 206 and an output device 208.

The computer processor 200 may be constituted by one or more conventional processors. Processor 200 operates to execute processor-executable steps, contained in program instructions described below, so as to control the OBO service provider computer 108 to provide desired functionality.

Communication device 201 may be used to facilitate communication with, for example, other devices (such as the acquirer computer 102). Communication device 201 may, for example, have capabilities for engaging in data communication over conventional computer-to-computer data networks.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of the listed storage devices may be referred to as a “memory” or a “storage medium”.

Storage device 204 stores one or more programs for controlling processor 200. The programs comprise program instructions that contain processor-executable process steps of OBO service provider computer 108, including, in some cases, process steps that constitute processes provided in accordance with principles of the present invention, as described in more detail below.

The programs may include an application 210 that manages a process by which customers (i.e., cardholders) may register themselves and/or their mobile devices with the OBO service provider computer 108. In some embodiments, the cardholder enrollment process may allow the cardholders to register themselves with the OBO service provider computer 108 by accessing via their mobile telephone 112 a suitable web page hosted by the OBO service provider computer 108. The information gathered from the cardholder during the registration process may include payment card account number and mobile telephone number (or other mobile identifier). The enrollment process may also require the cardholder to select a mobile personal identification number (M-PIN) to be used for security purposes in connection with payment card system purchase transactions to be initiated by the cardholder.

In addition or alternatively, the registration of cardholders with the OBO service provider computer 108 may be a batch process in which issuers of the cardholders' payment card accounts transfer information about the cardholders to the OBO service provider computer 108.

The storage device 204 may also store an application 212 for controlling the OBO service provider computer 108 to provide account support services to the cardholders. Details of the account support services will be provided below.

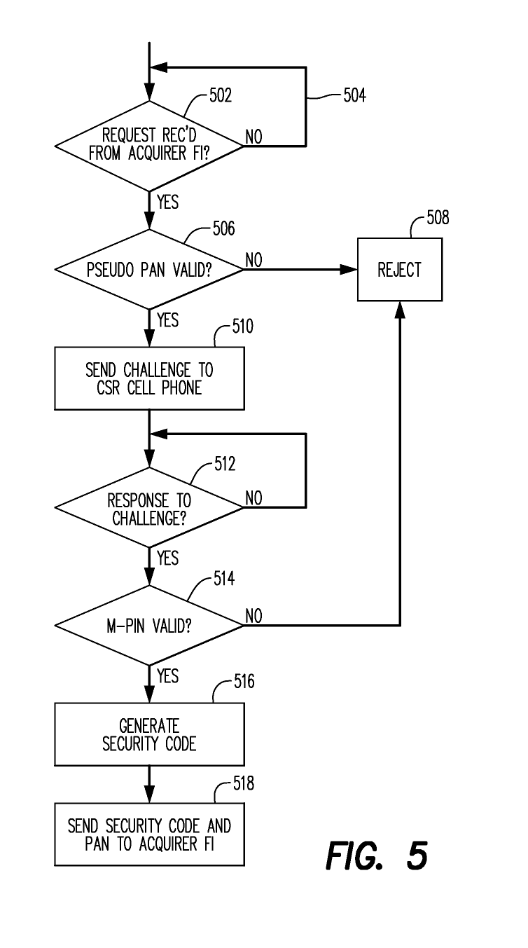

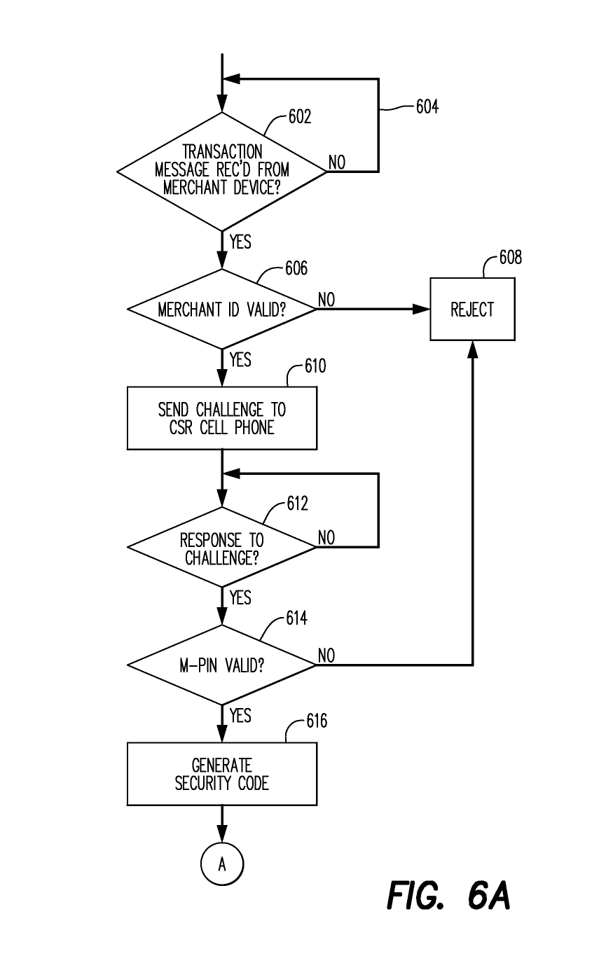

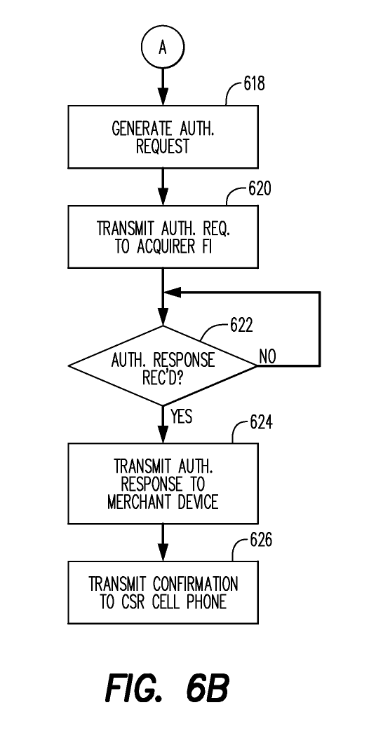

Another application that may be stored by the storage device 204 is for handling individual transactions and is indicated by reference numeral 214 in FIG. 2. Details of operation of the transaction handling application 214 in accordance with various aspects of the invention will be discussed hereinbelow, particularly with reference to FIGS. 5 and 6A-6B.

Still another application 216 may be stored by the storage device 204 and may control the OBO service provider computer 108 to provide customer care services that will be described below.

In addition, an application 218 may be stored by the storage device 204, and may control the OBO service provider computer 108 to provide mobile wallet services that will be described below.

Still further, the storage device 204 may store an application 220 for controlling the OBO service provider computer 108 to provide mobile banking services that will be described below.

Moreover, the storage device 204 may store an application 222 that controls the OBO service provider computer 108 to provide stored value account management services, as described below.

Also, an application 224 may be stored in the storage device 204 to control the OBO service provider computer 108 to provide functions related to data and communication security, including data encryption and encryption key management.

A further application 226 may be stored in the storage device 204 to control the OBO service provider computer 108 to provide reports to customers and/or operators of the OBO service provider computer 108.

Still another application 228 may be stored in the storage device 204 and may control the OBO service provider computer 108 to perform billing functions to charge acquirers and/or issuers for services provided by the OBO service provider computer 108.

Reference numeral 230 in FIG. 2 identifies one or more databases that are maintained by the OBO service provider computer 108 on the storage device 204. Among these databases may be a customer database, a merchant database, an issuer database, an acquirer database and a transaction database.

The application programs of the OBO service provider computer 108, as described above, may be combined in some embodiments, as convenient, into one, two or more application programs. Moreover, the storage device 204 may store other programs, such as one or more operating systems, device drivers, database management software, web hosting software, etc.

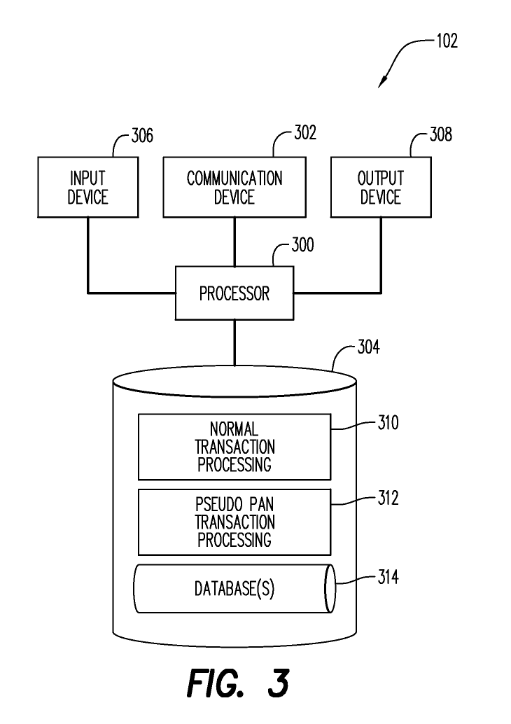

FIG. 3 is a block diagram of the acquirer computer 102 that is part of the transaction-handling system 100 shown in FIG. 1. The hardware architecture of the acquirer computer 102 may be conventional and may be the same as that of the OBO service provider computer 108. Thus, the above description of the hardware aspects of the OBO service provider computer 108 is equally applicable to the hardware aspects of the acquirer computer 102. Nevertheless, the following description is provided to summarize the hardware components of the acquirer computer 102.

The acquirer computer 102 may include a processor 300 that is in communication with a communication device 301, a storage device 304, an input device 306 and an output device 308. The storage device 304 may store an application program or program module 310 which controls the acquirer computer 102 to handle normal transactions in a conventional manner. As used in the previous sentence, “normal transactions” refers to purchase transaction authorization requests that include the PAN for the account to which the transaction is to be charged.

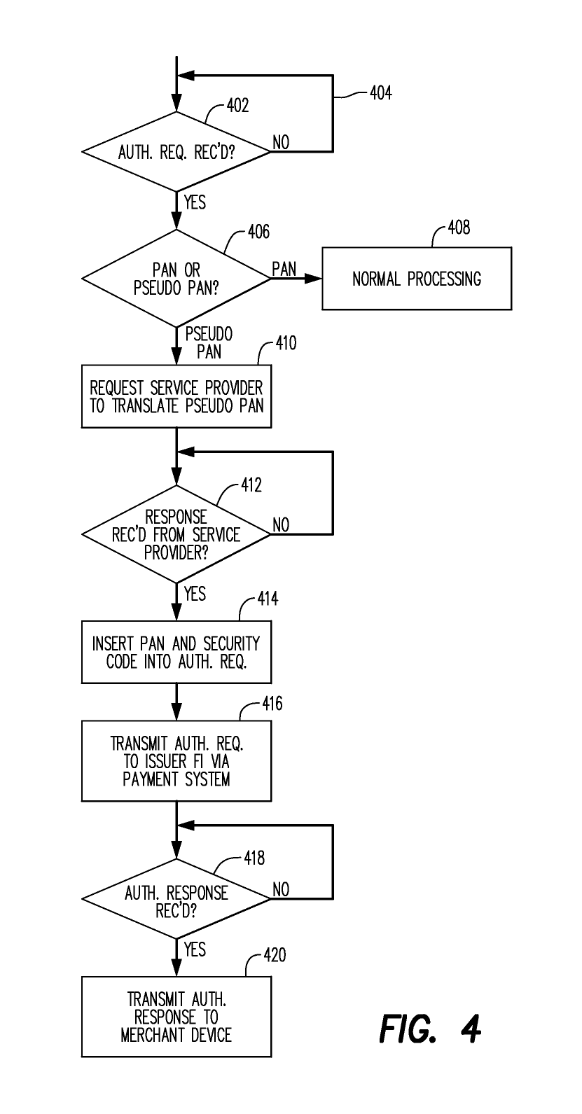

The storage device 304 may further store an application program/program module 312 that controls the acquirer computer 102 to handle authorization requests that include a “pseudo PAN” rather than a PAN. As used herein, “pseudo PAN” refers to a customer identifier other than a payment card account PAN. For example, in some embodiments, the pseudo PAN may be the customer's mobile telephone number. Details of the functionality provided by the program/program module 312 will be provided below, particularly in connection with FIG. 4.

In addition, the storage device 304 may store one or more databases 314 that are used by the acquirer computer 102 in handling transactions.

FIG. 4 is a flow chart that illustrates a process that may be performed by the acquirer computer 102 in accordance with aspects of the present invention.

At 402 in FIG. 4, the acquirer computer 102 determines whether it has received a purchase transaction authorization request. The authorization request, if received, may have been transmitted to the acquirer computer 102 by the merchant device 110 as indicated at 114 in FIG. 1. Until the acquirer computer 102 receives an authorization request, the process of FIG. 4 may idle, as indicated by branch 404 in FIG. 4.

If an authorization request is received at 402, then the process of FIG. 4 advances from 402 to decision block 406. At 406, the acquirer computer 102 determines whether the authorization request includes a PAN or a pseudo PAN.

In various embodiments, there are a number of different ways in which the acquirer computer 102 may determine whether the authorization request includes a pseudo PAN. For example, in some embodiments, the merchant device 110 (FIG. 1) may have operated to flag the authorization request to indicate that the authorization request includes a pseudo PAN. For example, the merchant employee who operates the merchant device 110 may have actuated an appropriate key or operated an editing function on the merchant device 110 to cause the merchant device to flag the transaction as including a pseudo PAN. For example, in some embodiments, the customer/cardholder may have entered the pseudo PAN and a card PIN (personal identification number) into the merchant device 110 by operating a keypad associated with the merchant device 110. In such a case, the pseudo PAN and the card PIN may be included in the authorization request sent from the merchant device 110 to the acquirer computer 102. The authorization request may also include conventional information for a purchase transaction authorization request, including a transaction amount and a merchant identifier. As noted above, in some embodiments the pseudo PAN may be the customer's mobile telephone number. In some embodiments, the acquirer computer 102 may determine whether the authorization request includes a PAN or a pseudo PAN based at least in part on the format (e.g., number of digits) of the PAN or pseudo PAN

If at 406 the acquirer computer 102 determines that the authorization request received from the merchant device 110 includes a PAN, then the process of FIG. 4 may advance from 406 to block 408. At 408, the acquirer computer 102 may handle the authorization request in a conventional manner. That is, the acquirer computer 102 may transmit the authorization request to the payment system 104 (FIG. 1) for routing to the issuer FI 106, as indicated by the PAN.

Continuing to refer to FIG. 4, if at 406 the acquirer computer 102 determines that the authorization request received from the merchant device 110 includes a pseudo PAN, then the process of FIG. 4 may advance from 406 to block 410. At 410, the acquirer computer 102 transmits a request (reference numeral 116 in FIG. 1) to the OBO service provider computer 108 to request that the OBO service provider computer 108 translate the pseudo PAN into the PAN for the payment card account to which the transaction is to be charged. It will be appreciated that the request includes the pseudo PAN received by the acquirer computer 102 in the authorization request from the merchant device 110.

Following 410, the process of FIG. 4 may idle, as indicated at 412, while the acquirer computer 102 awaits a response from the OBO service provider computer 108 to the pseudo PAN translation request. Once the acquirer computer 102 receives the response (reference numeral 118 in FIG. 1) from the OBO service provider computer 108, the process of FIG. 4 may advance from 412 to 414. As will be understood in view of the subsequent discussion of activities of the OBO service provider computer 108, the response received by the acquirer computer 102 may include the PAN for the customer in question, along with a security code generated by the service provider. At 414, the acquirer computer 102 generates an authorization request based on the authorization request received from the merchant device 110, but with the PAN and security code received from the OBO service provider computer 108 inserted into the authorization request by the acquirer computer 102. In the authorization request as generated by the acquirer computer 102, the PAN received from the OBO service provider computer 108 is substituted for the pseudo PAN that was received in the authorization request from the merchant device 110. The authorization request as generated by the acquirer computer 102 may include the card PIN received by the acquirer computer 102 from the merchant device 110.

In the process of FIG. 4, block 416 follows 414. At 416, the acquirer computer 102 transmits the authorization request generated at 414 to the payment system 104 (FIG. 1) for routing to the issuer FI 106, as indicated by the PAN provided by the OBO service provider computer 108. The authorization request as generated at 414 and transmitted at 416 (the authorization request also indicated by reference numerals 120 and 122 in FIG. 1) may include all data elements customarily included in an authorization request provided by an acquirer in accordance with conventional practices. The authorization request may be processed by the payment system 104 and the issuer FI 106 in a conventional manner.

Following 416, the process of FIG. 4 may idle, as indicated at 418, while the acquirer computer 102 awaits a response from the issuer 106 to the authorization request. Once the acquirer computer 102 receives the authorization response from the issuer 106 (the authorization response also indicated by reference numerals 124 and 126 in FIG. 1), the process of FIG. 4 may advance from 418 to 420. At 420, the acquirer computer 102 transmits the authorization response (indicated at this point by reference numeral 128 in FIG. 1) to the merchant device 110. This may be done generally in accordance with conventional practices. For example, the authorization response transmitted from the acquirer computer 102 to the merchant device 110 may include the merchant's transaction identification number and the PAN to which the transaction will be charged. This allows the merchant device 112 to print a truncated version of the PAN on the customer's receipt in accordance with conventional practices.

FIG. 5 is a flow chart that illustrates a process that may be performed by the OBO service provider computer 108 in accordance with aspects of the present invention.

At 502 in FIG. 5, the OBO service provider computer 108 determines whether it has received a request to translate a pseudo PAN into a PAN. This request may be of the type described above with respect to block 410 in FIG. 4 (and indicated at 116 in FIG. 1) and thus may be from the acquirer computer 102. It should be understood that the acquirer computer 102 shown in FIG. 1 and discussed in connection with FIGS. 4 and 5 may be one of numerous similar computers that are operated by or on behalf of various acquiring FIs and that are operated to send requests of this sort to the OBO service provider computer 108. Thus the OBO service provider computer 108 may provide services to numerous acquiring FIs.

As indicated by branch 504 from 502, the process of FIG. 5 may idle until a pseudo PAN translation request 116 (FIG. 1) is received. However, once the OBO service provider computer 108 receives such a request, the process of FIG. 5 may advance from 502 to 506. At 506, the OBO service provider computer 108 may determine whether the pseudo PAN received in the request is valid. This may be done, for example, by the OBO service provider computer 108 looking up the pseudo PAN in a database of registered users. If the pseudo PAN received at 502 matches a pseudo PAN for a validly registered user, then the OBO service provider computer 108 may determine that the pseudo PAN is valid. If not, then the OBO service provider computer 108 may determine that the pseudo PAN is invalid.

In the latter case, the process of FIG. 5 may advance from 506 to block 508. At block 508, the OBO service provider computer 108 may provide a “decline” or “reject” message to the acquirer computer 102 as a response to the request received at 502. (In this case, the acquirer computer 102 may provide a negative authorization response to the merchant device 110). In some embodiments, the “reject” message from the OBO service provider computer 108 to the acquirer computer 102 may include a reason (e.g., “invalid pseudo PAN”) for the rejection.

In the former case (i.e., if the OBO service provider computer 108 determines at 506 that the pseudo PAN in the request was valid), then the process of FIG. 5 may advance from 506 to block 510. At block 510, the OBO service provider computer 108 may issue a challenge (reference numeral 130 in FIG. 1) to the customer mobile telephone 112. For example, the subscriber profile looked up in connection with the pseudo PAN may indicate what method of challenge the OBO service provider computer 108 is to use. In addition or alternatively, the pseudo PAN itself may be the telephone number for the mobile telephone 112 and may provide the information needed for the OBO service provider computer 108 to initiate the challenge. In some embodiments, the challenge may take the form of a text message sent by the OBO service provider computer 108 to the customer mobile telephone 112. In other embodiments, the challenge may take the form of initiating a telephone call (e.g., by an automatic device such as an interactive voice response—IVR—unit associated with/incorporated in the OBO service provider computer 108) to the customer mobile telephone 112.

(In some embodiments, a mobile device other than a mobile telephone may participate in the challenge and response functions described herein. For example, the challenge may alternatively be issued to a PDA (personal digital assistant) with mobile communication capabilities that is registered to the customer in question. For example, the challenge may take the form of an electronic mail message to the mobile device. In other embodiments, the challenge and response may be performed in a mobile messaging session between the mobile device/telephone and the service provider. The mobile device/telephone may have been programmed with a suitable application program to support receiving and responding to challenges from the OBO service provider computer 108.)

Following 510, the process of FIG. 5 may idle, as indicated at 512, while the OBO service provider computer 108 awaits a response from the customer to the challenge issued at 5 10. In some embodiments, the challenge prompts the customer to enter a mobile PIN (M-PIN) into the mobile telephone 112 and to transmit the M-PIN (e.g., via a text message, or via keyboard entry in response to a query from an IVR unit, etc.) to the service provider. (In a preferred embodiment, the M-PIN must be manually entered into the mobile telephone 112 by the customer in response to the challenge, and is not stored in the mobile telephone. In some embodiments, the M-PIN may be encrypted by the mobile telephone 112 before it is transmitted to the OBO service provider computer 108. In some embodiments, the customer may have the option of declining the transaction instead of entering the M-PIN in response to the challenge.) Once the OBO service provider computer 108 receives the response from the mobile telephone 112 (reference numeral 132 in FIG. 1 indicates the response), the process of FIG. 5 may advance from 512 to 514. At 514, the OBO service provider computer 108 may determine whether the M-PIN received from the mobile telephone 112 is valid. This may be done, for example, by referring to the subscriber profile stored by the OBO service provider computer 108 for the customer in question. (If the M-PIN was encrypted by the mobile telephone 112, the processing at 514 may include decrypting the M-PIN.) It will be appreciated that the valid M-PIN may have previously been selected by or assigned to the customer and stored in the customer's profile in a database maintained in the OBO service provider computer 108.

If the OBO service provider computer 108 determines at 514 that the M-PIN is not valid (or if the customer declines the transaction), the process of FIG. 5 may advance from 514 to 508. At 508, as before, the OBO service provider computer 108 may provide a “decline” or “reject” message to the acquirer computer 102. In some embodiments, the reject message may provide a specific reason for rejecting the transaction such as “M-PIN not valid” or “customer declines transaction”.

If the OBO service provider computer 108 determines at 514 that the M-PIN received from the mobile telephone 112 is valid, then the process of FIG. 5 may advance from 514 to block 516. At block 516, the OBO service provider computer 108 may generate a security code for the transaction. This may include simply looking up the security code from the customer's profile, or may include generating the security code in accordance with a conventional algorithm. In some embodiments the security code may be of the type known as an “AAV” or a “CVC2”.

After 516, the process of FIG. 5 may advance to block 518. At block 518, the OBO service provider computer 108 may generate and transmit to the acquirer computer 102 the response indicated at 118 in FIG. 1 and referred to above in connection with block 412 in FIG. 4. That is, the response from the OBO service provider computer 108 to the acquirer computer 102 may include both the security code generated at 516 and the customer PAN which corresponds to the pseudo PAN received by the OBO service provider computer 108 at 502. It will be appreciated that the OBO service provider computer 108 may have looked up the customer PAN from the customer's profile in a database maintained by the OBO service provider computer 108.

In the above scenario (FIGS. 1, 4 and 5), the OBO service provider computer 108 may be considered to have provided OBO services both for the acquirer and the issuer. In particular, the OBO services provided by the OBO service provider computer 108 for the acquirer may be considered to include pseudo PAN to PAN translation and provision of the security code. The OBO services provided by the OBO service provider computer 108 for the issuer may be considered to include the transaction security process that involves challenge and response to the customer's mobile telephone. In some respects the services provided by the OBO service provider computer 108 may be considered to overlap or blend OBO services to the acquirer and the issuer. With the OBO service provider computer 108 providing these services, relatively few modifications to existing practices may be required of the acquirers and issuers in order to implement a highly convenient and secure mobile telephone/device based payment system that cost-effectively piggybacks on existing payment card system infrastructure.

FIGS. 6A-6B together form a flow chart that illustrates a process that may be performed by the OBO service provider computer 108 in accordance with other aspects of the present invention.

The process depicted in FIGS. 6A-6B assumes a somewhat different message flow from that illustrated in FIG. 1. According to the modified message flow contemplated by FIGS. 6A-6B, the merchant device 110 (FIG. 1) engages in communications with the OBO service provider computer 108 rather than with the acquirer computer 102. Otherwise the overall message flow of FIG. 1 is generally similar to that previously described. Differences between the previously described and modified messages flows will be further explained in conjunction with FIGS. 6A-6B.

Referring, then, to FIG. 6A, at 602 the OBO service provider computer 108 determines whether it has received a transaction message from the merchant device 110. (Although only one merchant device 110 is shown in FIG. 1, in practice there may be a large number of merchant devices that may from time to time transmit transaction messages to the OBO service provider computer 108.) In the embodiment illustrated in FIGS. 6A-6B, the merchant device 110 submits the transaction message to the OBO service provider computer 108 in lieu of sending an authorization request directly to an acquirer. Hence, in functional terms, the transaction message may be considered to be an authorization request, and may include the amount of the transaction, a merchant identifier and/or a merchant device identifier and other pertinent information.

(It is assumed that the merchant and/or the merchant device 110 have previously been registered with the OBO service provider computer 108 as an authorized merchant for the mobile device based payment system described herein.)

Prior to transmitting the transaction message, the merchant may have entered the customer's pseudo PAN into the merchant device 110 along with other information (e.g., transaction amount) relevant to the transaction in question. In some embodiments, the merchant and the merchant device may be remote from the customer at the time of the transaction, as in the case of a purchase or other transaction carried out by telephone. In other embodiments, the customer may be present at the merchant device 110 and may himself/herself enter his/her pseudo PAN into the merchant device 110.

Until the OBO service provider computer 108 receives a transaction message, the process of FIGS. 6A-6B may idle, as indicated by branch 604 in FIG. 6A. If a transaction message is received by the OBO service provider computer 108 from the merchant device 110, then the process of FIGS. 6A-6B advances from 602 to decision block 606. At decision block 606, the OBO service provider computer 108 determines whether the merchant identifier/merchant device identifier in the transaction message is valid. That is, the OBO service provider computer 108 may use the merchant identifier/merchant device identifier included in the transaction message to access a database of registered merchants/merchant devices to determine whether there is a matching merchant identifier/merchant device identifier in the database. If not, then the process of FIGS. 6A-6B may advance from 606 to block 608. At block 608, the OBO service provider computer 108 sends a message back to the merchant device 110 to indicate that the transaction is rejected.

In some embodiments, it may also be required that the transaction message include a merchant PIN. If so, block 606 may also include looking up and validating the merchant PIN. In other embodiments, no PIN is required from the merchant device 110.

Considering again decision block 606, if the OBO service provider computer 108 determines that the merchant identifier/merchant device identifier is valid, then the process of FIGS. 6A-6B may advance from 606 to block 610. At block 610, the OBO service provider computer 108 may issue a challenge to the customer mobile telephone 112. This challenge, and the customer's response, may be the same as or similar to the challenge and response described hereinabove in connection with blocks 510 and 512 of FIG. 5.

Following 610, the process of FIGS. 6A-6B may idle, as indicated at 612, while the OBO service provider computer 108 awaits a response from the customer to the challenge issued at 610. Once the OBO service provider computer 108 receives the response from the mobile telephone 112, the process of FIGS. 6A-6B may advance from 612 to 614. At 614, the OBO service provider computer 108 may determine whether an M-PIN received from the mobile telephone 112, in response to the challenge, is valid. This may be done in the same manner described above in connection with block 514 in FIG. 5. If the OBO service provider computer 108 determines at 614 that the M-PIN is not valid (or if the customer declined the transaction), the process of FIGS. 6A-6B may advance from 614 to block 608. At block 608, the OBO service provider computer 108 may provide a “decline” or “reject” message to the merchant device 110. In some embodiments, that message may include a specific reason such as “M-PIN not valid” or “customer declines transaction”.

If the OBO service provider computer 108 determines at 614 that the M-PIN received from the mobile telephone 112 is valid, then the process of FIGS. 6A-6B may advance from 614 to 616. At 616, the OBO service provider computer 108 may generate a security code for the transaction. This may be done in the same manner as described hereinabove in connection with block 516 in FIG. 5.

After 616, the process of FIGS. 6A-6B may advance to block 618 (FIG. 6B). At 618, the OBO service provider computer 108 may generate an authorization request for the transaction. The authorization request may include the PAN for the customer, which the OBO service provider computer 108 may have looked up from its database of customer profiles, based on the pseudo PAN included in the transaction message received from the merchant device 110 at step 602 (FIG. 6A). The authorization request may also include the security code generated by the OBO service provider computer 108 at 616. The authorization request may be in substantially the same format as that used for purchase transaction authorization requests conventionally provided by merchants to acquirer FIs in payment card systems. The authorization request may for example include the amount of the transaction and a merchant identifier that identifies the merchant which sent the transaction message to the OBO service provider computer 108.

The process of FIGS. 6A-6B may advance from 618 to block 620 (FIG. 6B). At 620 the OBO service provider computer 108 may transmit, to the acquirer computer 102, the authorization request generated by the OBO service provider computer 108 at 618. Following 620, the process of FIGS. 6A-6B may idle, as indicated at 622 in FIG. 6B, while the OBO service provider computer 108 awaits a response from the acquirer computer 102 to the authorization request. It should be understood that the acquirer computer 102, the payment system 104 and the issuer 106 may handle and respond to the authorization request in a conventional manner. As a result, the issuer 106 may generate an authorization response that is routed back to the OBO service provider computer 108 via the payment system 104 and the acquirer computer 102. Once the OBO service provider computer 108 receives the authorization response from the acquirer computer 102, the process of FIGS. 6A-6B may advance from 622 to 624. At 624, the OBO service provider computer 108 may transmit the authorization response to the merchant device 110. In addition, at 626, the OBO service provider computer 108 may transmit a message to the customer's mobile telephone 112 to confirm that the transaction has been authorized.

The process of FIGS. 6A-6B may provide many of the benefits discussed above in connection with FIGS. 1, 4 and 5, including implementation of a mobile telephone/device based payment system built on the foundation of existing payment card system infrastructure, while requiring minimal or no changes in operation on the part of acquirer and issuer FIs.

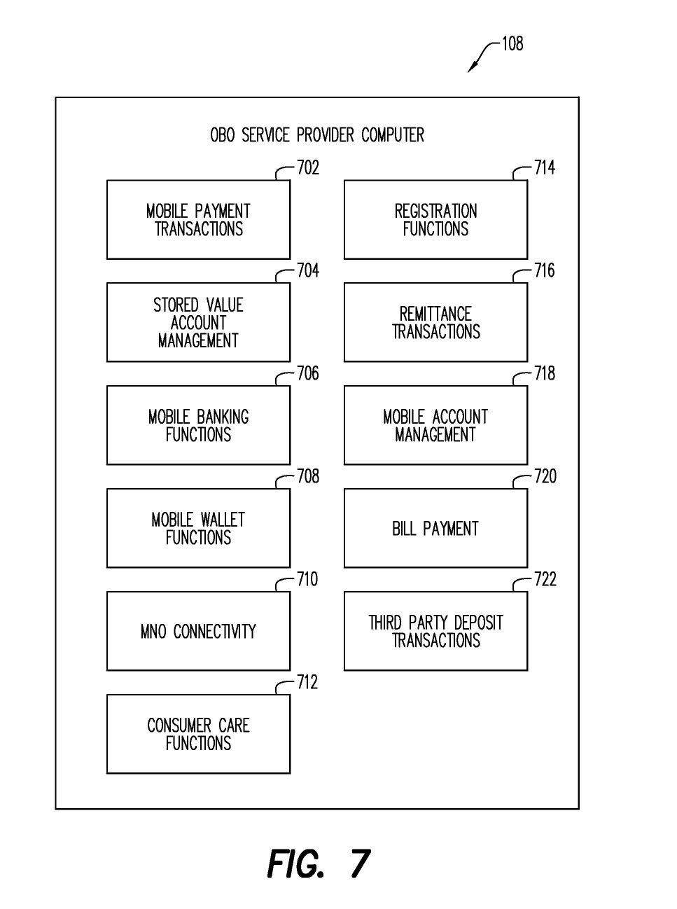

In addition to the core functionality described above with reference to FIGS. 1 and 4-6B, the OBO service provider computer 108 may provide other features and functions to enhance the usefulness and customer-friendliness of the mobile telephone/device based payment system. FIG. 7 is block diagram that illustrates functionality that may be provided by the OBO service provider computer 108. Block 702 in FIG. 7 represents the purchase transaction functionality illustrated in FIGS. 6A and 6B.

For example, the OBO service provider computer 108 may manage stored-value accounts for the registered subscribers. (This functionality is indicated by block 704 in FIG. 7.) The stored-value accounts, in some embodiments, may be funded by one or more of: (a) cash loading from merchant POS terminals, (b) direct debit from a bank direct deposit account (DDA), funding from a credit or debit card account, and account to account transfers. The OBO service provider computer 108 may provide daily account balance reconciliation and settlement information for the stored-value accounts.

Also or alternatively, the OBO service provider computer 108 may enable customers to access their bank account information, perform core banking transactions and request information from their banks via the customer's mobile telephone/device (this functionality indicated by block 706 in FIG. 7). These accesses may include account balance inquiries, requesting information regarding the last X transactions, requesting an account statement, requesting information about rates and charges, and activity alerts and notifications (e.g., based on SMS), including for example notification of payroll deposits.

The OBO service provider computer 108 may also function as a general mobile wallet server (block 708, FIG. 7), to permit the customer's payment card account to be linked to the mobile service account. This functionality may support transaction types such as (a) mobile service top-up, (b) remote merchant purchase, and (c) mobile service bill pay via recurring payment.

The OBO service provider computer 108 may also supply connectivity (block 710, FIG. 7) to mobile network operators (MNOs) so that the payment system is portable across mobile service providers. This connectivity may include the physical and logical connectivity between MNO messaging systems and the OBO service provider computer 108, including signaling links, messaging links, and data communications to enable communication between the OBO service provider computer 108 and the mobile payment application in the customer mobile telephone/device.

Still further, the OBO service provider computer 108 may supply various customer care features (block 712, FIG. 7), including mobile payments account customer registration, linking between payment account and mobile account, reporting and administrative support. The administrative functions for issuers and acquirers may be accessed via a Web-based interface. The OBO service provider computer 108 may provide customer “self-care” capabilities such as prepaid account balance and activity queries, and mobile payment account profiles. The OBO service provider computer 108 may further provide reporting capabilities, including end-of-day summary reports and online reporting for acquirers and issuers via a Web-based interface. The reports may include statistical information relating to each FI's subscribers, mobile payment transactions by subscriber, audit reports, etc. Still further, the OBO service provider computer 108 may implement billing for its services to the acquirers and issuers.

In addition, the OBO service provider computer 108 may provide capabilities for registration (block 714, FIG. 7) of customers, issuers, MNOs and merchants. Customers may be required to open a prepaid payment card account with a registered issuer as a prerequisite for registration in the mobile payments system. Anti-money laundering and “know your customer” compliance may be handled by the issuing FI with respect to the payment card account. Registration of merchants with the OBO service provider computer 108 may be performed by the acquiring FIs.

Still further, the OBO service provider computer 108 may support person-to-person remittance transactions (block 716, FIG. 7), utilizing, for example, the “payment transaction” capabilities of the underlying payment card system.

One implementation of the above-mentioned mobile account top-up function may operate as follows. (This may be included in mobile account management functionality, represented by block 718, FIG. 7.) First, the customer may select the “top-up” feature from the device menu. Next the customer may send the transaction request to the OBO service provider computer 108. The OBO service provider computer 108 may validate the pseudo PAN and perform the above-described challenge-and-response process, including M-PIN validation, with the customer's mobile telephone/device. The OBO service provider computer 108 may next generate the security code and perform a PAN look-up for the customer, and then transmit an appropriate authorization request to the acquirer for the customer's MNO. After conventional handling of the authorization request via the acquirer, payment system and issuer, the OBO service provider computer 108 receives the authorization response and (if the auth response is positive) sends a top-up credit message to the MNO and a confirmation/receipt message to the customer's mobile telephone/device.

One implementation of the above-mentioned person-to-person remittance feature (block 716, FIG. 7) may operate as follows. Initially the customer selects the remittance feature from the device menu. Then the customer sends the transaction request to the OBO service provider computer 108. Next, the OBO service provider computer 108 validates the mobile device identifier (pseudo PAN) and performs the above-described challenge-and-response process, with M-PIN validation, with respect to the customer's mobile telephone/device. The OBO service provider computer 108 then initiates a payment transaction through the payment system via the issuer of the customer's payment card account. The payment transaction may, for example, conform to the process for remittances via a payment card system, as described in co-pending, commonly assigned U.S. patent application Ser. No. 11/839,956, filed Aug. 10, 2007, which is incorporated herein by reference. Upon approval of the payment transaction via the sending and receiving issuers and the payment system, the OBO service provider computer 108 may send a confirmation/receipt message to the customer and a notification message to the recipient.

The OBO service provider computer 108 may also provide a bill payment function (block 720, FIG. 7), which may be implemented as follows. Initially, the OBO service provider computer 108 may receive from a billing entity (e.g., a utility company or the like) a data file containing details of individual accounts being billed by the entity. The OBO service provider computer 108 then sends a bill due notice message to the customer's mobile telephone/device. The customer selects a bill payment feature from the menu presented by the mobile telephone/device and sends a bill pay transaction message from the mobile telephone/device to the OBO service provider computer 108. The OBO service provider computer 108 may validate the pseudo PAN and perform the above-described challenge-and-response process, including M-PIN validation, with the customer's mobile telephone/device. The OBO service provider computer 108 may next generate the security code and perform a PAN look-up for the customer, and then transmit an appropriate authorization request to the acquirer for the billing entity. After conventional handling of the authorization request via the acquirer, payment system and issuer, the OBO service provider computer 108 receives the authorization response and (if the auth response is positive) sends a payment advice message to the billing entity and a confirmation/receipt message to the customer's mobile telephone/device.

An implementation of an account-to-account transfer function (mobile banking, block 706, FIG. 7) may operate as follows. This process assumes that both accounts are maintained by the issuer of the customer's payment card account First, the customer may select an account transfer feature from the menu provided by his/her mobile telephone/device. The customer may then send the account transfer transaction to the OBO service provider computer 108. The OBO service provider computer 108 may validate the pseudo PAN and perform the above-described challenge-and-response process, including M-PIN validation, with the customer's mobile telephone/device. The OBO service provider computer 108 may next send an account transfer request message to the issuer of the customer's payment card account. The issuer may perform the account transfer within its internal systems as an “on-us” transaction and then send a response message to the OBO service provider computer 108. The OBO service provider computer 108 may then send a confirmation/receipt message to the customer's mobile telephone device.

An implementation of the above-mentioned balance query function (mobile banking, block 706, FIG. 7) may operate as follows. First, the customer may select a balance query feature from the menu provided by his/her mobile telephone/device. The customer may then send the balance query to the OBO service provider computer 108. The OBO service provider computer 108 may validate the pseudo PAN and perform the above-described challenge-and-response process, including M-PIN validation, with the customer's mobile telephone/device. The OBO service provider computer 108 may next send the balance query to the issuer of the customer's payment card account. The issuer may perform an account balance lookup within its internal systems as an “on-us” transaction and then send a response to the query to the OBO service provider computer 108. The OBO service provider computer 108 may then send the response to the customer's mobile telephone/device. An account activity query function and an account rates and fees query function may be performed in a similar fashion. Similarly, a statement request function may be similar, but with the concluding step being issuance of the statement (by electronic mail or hard copy mail) from the issuer to the customer.

Still further, the system may implement a function (mobile banking, block 706, FIG. 7) with respect to bank branch/bank agent cash loads for the customer's payment card account. This may be performed as follows. The customer may visit a bank branch or bank agent and deliver cash over the counter. The branch agent may then provide a deposit receipt to the customer. The issuer of the payment card account then credits the account with the amount of the cash deposit, and sends an administrative advice message to that effect to the OBO service provider computer 108 via the payment system 104. The OBO service provider computer 108 provides a suitable response/acknowledgment back through the payment system 104 to the issuer. Next the OBO service provider computer 108 validates the customer's PAN and looks up the mobile phone number or other mobile device identifier for the customer. Finally, the OBO service provider computer 108 provides a deposit notification message to the customer via SMS messaging to the customer's mobile telephone/device.

The system may further implement, as follows, cash loads (mobile banking, block 706, FIG. 7) to the customer's payment card account via merchant locations. The customer may visit the merchant location and deliver cash to the merchant. The merchant may then initiate a payment card system payment transaction via the merchant's acquirer FI and the payment system and targeted to the issuer of the customer's payment card account. The payment transaction may be performed in a conventional manner, including an auth request from the merchant that includes the load amount and the customer's PAN. The issuer of the payment card account credits the account with the amount of the load, and sends an administrative message regarding the credit to the OBO service provider computer 108 via the payment system 104. The OBO service provider computer 108 provides a suitable response/acknowledgment back through the payment system 104 to the issuer. Next the OBO service provider computer 108 validates the customer's PAN and looks up the mobile phone number or other mobile device identifier for the customer. Finally, the OBO service provider computer 108 provides a load notification message to the customer via SMS messaging to the customer's mobile telephone/device.

Also, the system may implement a function for payroll or social benefits deposits (block 722, FIG. 7) to the customer's payment card account. First, the disbursing entity (e.g., government agency or customer's employer) may provide a batch file of disbursement instructions to the disbursing bank. The disbursing bank then sends a direct credit to the issuer of the customer's payment card account via an ACH system or the like. Next the issuer credits the disbursement to the customer's payment card account via the issuer's internal system. The issuer also sends an administrative message regarding the credit to the OBO service provider computer 108 via the payment system 104. The OBO service provider computer 108 provides a suitable response/acknowledgment back through the payment system 104 to the issuer. Next the OBO service provider computer 108 validates the customer's PAN and looks up the mobile phone number or other mobile device identifier for the customer. Finally, the OBO service provider computer 108 provides a deposit notification message to the customer via SMS messaging to the customer's mobile telephone/device.

The system may implement an account activity alert function (mobile banking, block 706, FIG. 7) as follows. First, the customer uses his/her payment card at a POS terminal or an ATM. The purchase transaction authorization request from the merchant or the withdrawal authorization request from the ATM proceed in a conventional manner, and the issuer debits the customer's payment card account in a conventional manner. The issuer also sends an administrative message regarding the debit to the OBO service provider computer 108 via the payment system 104. The OBO service provider computer 108 provides a suitable response/acknowledgment back through the payment system 104 to the issuer. Next the OBO service provider computer 108 validates the customer's PAN and looks up the mobile phone number or other mobile device identifier for the customer. Finally, the OBO service provider computer 108 provides an activity alert message to the customer via SMS messaging to the customer's mobile telephone/device.

The system may implement a low balance alert function (mobile banking, block 706, FIG. 7) as follows. When the issuer of the payment card account recognizes that the account balance is below a defined threshold, the issuer sends an administrative message, with transaction detail, to the OBO service provider computer 108 via the payment system 104. The OBO service provider computer 108 provides a suitable response/acknowledgment back through the payment system 104 to the issuer. Next the OBO service provider computer 108 validates the customer's PAN and looks up the mobile phone number or other mobile device identifier for the customer. Finally, the OBO service provider computer 108 provides a low balance alert message to the customer via SMS messaging to the customer's mobile telephone/device.

The above depictions and descriptions of processes herein are not intended to imply a fixed order of performing the process steps. Rather, the process steps may be performed in any order that is practicable.

As used herein and in the appended claims, the term “transaction amount” refers to a dollar or other currency amount of a purchase transaction.

It should be noted that the block 108 as depicted in FIG. 1 represents both the OBO service provider computer illustrated in FIG. 2 and the entity which operates the computer. In some embodiments, that entity may be a payment card association (such as MasterCard International Inc., which is the assignee hereof) or a contractor retained by the payment card association.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving from an acquiring financial institution (FI) a request to translate a customer identifier into a primary account number (PAN);
determining whether said customer identifier is valid;
if said customer identifier is determined to be valid, issuing a challenge to a mobile telephone operated by a customer identified by said customer identifier;
receiving a mobile personal identification number (PIN) from said customer;
determining whether said received mobile PIN is valid;
if said received mobile PIN is determined to be valid, generating a security code; and
transmitting, to said acquiring FI, said security code and the PAN that corresponds to said customer identifier.

2. The method of claim 1, wherein said customer identifier is a telephone number for said mobile telephone operated by said customer.

3. The method of claim 1, wherein said security code is at least one of an AAV code and a CVC2 code.

4. The method of claim 1, further comprising:
looking up said PAN based at least in part on said customer identifier.

5. The method of claim 1, wherein said challenge includes sending a text message to said mobile telephone.

6. The method of claim 1, wherein said challenge includes initiating a telephone call to said mobile telephone.

7. The method of claim 1, wherein said mobile PIN is received via a text message from said telephone.

8. The method of claim 1, wherein said mobile PIN is received via the customer interacting with an interactive voice response (IVR) system.

9. A method comprising:
receiving an authorization request from a merchant device, the authorization request including a customer identifier and a personal identification number (PIN);
transmitting, to a service provider, a request to translate the customer identifier into a primary account number (PAN);
receiving a response from the service provider, the response including a security code and the PAN that corresponds to said customer identifier;
generating a payment card system authorization request that includes the PAN and the security code;
transmitting the payment card system authorization request to an issuing financial institution (FI) via a payment card system;
receiving an authorization response via the payment card system; and
transmitting the authorization response to the merchant device.

10. The method of claim 9, wherein said security code is at least one of an AAV code and a CVC2 code.

11. The method of claim 9, wherein said customer number is a mobile telephone number.

12. The method of claim 9, wherein the authorization request received from the merchant device includes a transaction amount and a merchant identifier.

13. The method of claim 9, wherein the payment card system authorization request transmitted to the issuing financial institution includes the PIN.

14. A method comprising:
receiving a purchase transaction message from a merchant device, the message including a merchant identifier and a customer identifier;
determining whether said merchant identifier is valid;
if said merchant identifier is determined to be valid, determining whether said customer identifier is valid;
if said customer identifier is valid, issuing a challenge to a mobile telephone operated by a customer identified by said customer identifier;
receiving a mobile personal identification number (PIN) from said customer;
determining whether said received mobile PIN is valid;
if said received mobile PIN is valid, generating a security code;
transmitting, to an acquiring financial institution (FI), an authorization request, the authorization request including the security code and a primary account number (PAN) that corresponds to said customer identifier;
receiving an authorization response from the acquiring FI; and
transmitting the authorization response to the merchant device.

15. The method of claim 14, further comprising:
transmitting a confirmation message to the mobile telephone.

16. The method of claim 14, wherein said customer identifier is a telephone number for said mobile telephone operated by said customer.

17. The method of claim 14, wherein said security code is at least one of an AAV code and a CVC2 code.

18. The method of claim 14, further comprising:
looking up said PAN based at least in part on said customer identifier.

19. The method of claim 14, wherein said challenge includes sending a text message to said mobile telephone.

20. The method of claim 14, wherein said challenge includes initiating a telephone call to said mobile telephone.

21. The method of claim 14, wherein said mobile PIN is received via a text message from said telephone.

22. The method of claim 14, wherein said mobile PIN is received via the customer interacting with an interactive voice response (IVR) system.

23. The method of claim 14, wherein the purchase transaction message includes a transaction amount.
